(19) United States
(12) Patent Application Publication
(10) Pub. No.: US 2015/0211298 A1
(43) Pub. Date: Jul. 30, 2015

(54) CONVERTIBLE CART AND ELEVATED STAND APPARATUS

(71) Applicant: Allen Eugene Rogers, Owatonna, MN (US)

(72) Inventor: Allen Eugene Rogers, Owatonna, MN (US)

(21) Appl. No.: 14/607,411

(22) Filed: Jan. 28, 2015

Related U.S. Application Data
(60) Provisional application No. 61/932,521, filed on Jan. 28, 2014.

(51) Int. Cl. E06C 1/397; A01M 31/02

(52) U.S. Cl. CPC E06C 1/397; A01M 31/02

(57) ABSTRACT

A convertible cart and elevated stand apparatus comprising a cart member and stand member which are adapted to be removably coupled to each other to form an elevated stand. A cart member may include a first frame section comprising a first pair of cart longitudinal support bars adapted to be removably coupled to a stand member, and a second frame section pivotally coupled to the first frame section. A stand member may include a seat configured to support the weight of an individual which may be coupled to a pair of stand longitudinal support bars configured to be removably coupled with the first pair of cart longitudinal support bars of the first frame section. The cart longitudinal support bars and stand longitudinal support bars may each support a plurality of transverse rails configured to be used rungs for a ladder.

### CROSS REFERENCE TO RELATED APPLICATIONS

This application claims priority to and the benefit of the filing date of U.S. Provisional Application No. 61/932,521, filed on Jan. 28, 2014, entitled “COMBINATION TREE STAND & GAME CART”, which is hereby incorporated by reference in its entirety.

### FIELD OF THE INVENTION

This patent specification relates to the field of hunting and transportation apparatuses. More specifically, this patent specification relates to apparatuses that may be converted between a transporting cart and an elevated stand for use during outdoor activities such as hunting.

### BACKGROUND

Many outdoor activities such as hunting require the transportation of items from one place to another. Hunters typically are required to move items such as firearms, food and food storage containers, hunting support structures such as tree stands and blinds, chairs, and the like over rough or uneven terrain. Additionally, upon completion of a successful hunt, a hunter is often required to move these items along with the carcass of the taken animal. These transportation requirements frequently reduce the amount and quality of time an individual can devote to outdoor activities such as hunting.

While some devices seek to provide a cart with wheels that is adapted to receive items for transportation over rough or uneven terrain, these carts are limited in size. Large objects such as tree stands and boats are unable to be received by these carts resulting in the need for multiple transporting trips from one or more individuals. Other carts may be larger in size and convertible to hunting support structures, but they require a large amount of time for assembly and disassembly during their reconfiguration. Still other carts seek to transport large objects; however, these carts are only configured to accommodate a specific center of gravity location of the one or more objects on the cart. If the objects are bulky or must be positioned so that the center of gravity is not in a specific location of the cart, the cart may become unwieldy and the transporting individual may have great difficulty in moving the cart. All of these disadvantages contribute to reducing the amount and quality of time an individual can devote to outdoor activities such as hunting.

Therefore, a need exists for novel hunting and transportation apparatuses. There also exists a need for novel hunting and transportation apparatuses that are able to receive items of different sizes and shapes to facilitate transportation across various terrains. There is a further need for novel hunting and transportation apparatuses that may be reconfigured without requiring a large amount of time for assembly and disassembly during their reconfiguration. Finally, there exists a need for novel hunting and transportation apparatuses that are able to receive items with various centers of gravity without becoming unwieldy and hindering the ability of an individual to move the loaded apparatus.

### BRIEF SUMMARY OF THE INVENTION

A convertible cart and elevated stand apparatus is provided. In some embodiments, the apparatus may comprise a cart member and stand member which are adapted to be removably coupled to each other to form an elevated stand. A cart member may include a first frame section comprising a first pair of cart longitudinal support bars each having a distal end and a proximal end with each of the distal ends adapted to be removably coupled to a stand member, and a second frame section comprising a second pair of cart longitudinal support bars each having a distal end and a proximal end with each of the proximal ends pivotally coupled to the proximal ends of the pair of longitudinal support bars of the first frame section. A stand member may include a pair of stand longitudinal support bars each having a distal end and a proximal end with the proximal ends configured to be removably coupled with the distal ends of the first pair of cart longitudinal support bars of the first frame section.

In further embodiments, the first pair of cart longitudinal support bars and stand longitudinal support bars may each support a plurality of transverse rails configured to be used rungs for a ladder.

In still further embodiments, the stand member may also include a pair of upper platform support bars rotatably coupled to the distal ends of the stand longitudinal support bars and a pair of lower platform support bars coupled to the stand member proximate to a location between the stand longitudinal support bars distal ends and proximate ends with the pair of lower platform support bars configured to support the weight of the upper platform support bars with a brace.

In further embodiments, a stand member may comprise a pair of arm rests removably coupled to the pair of upper platform support bars with one of the of arm rests coupled to and supporting a removable utility tray.

In still further embodiments, the apparatus may comprise a canopy frame which may be removably coupled to portions of a stand member such as one or more upper platform support bars and/or a platform support board to provide protection from the sun, rain and other elements to an individual sitting or standing on the elevated stand of the stand member. In some embodiments, the apparatus may comprise one or more such as a pair of anchor pegs which may be positioned on each of the upper platform support bars. The anchor pegs may be configured to removably secure or removably connect portions of a canopy frame to the stand member such as by inserting the anchor pegs into portions of the canopy frame or by inserting portions of the canopy frame into the anchor pegs.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a convertible cart and elevated stand apparatus in an elevated stand configuration against a tree trunk according to various embodiments described herein.

FIG. 2 illustrates a side elevation view of an example of a convertible cart and elevated stand apparatus in an elevated stand configuration according to various embodiments described herein.

FIG. 3 shows an exploded plan view of an example of a stand member according to various embodiments described herein.

FIG. 4 depicts a perspective view of an example of a stand member according to various embodiments described herein.

FIG. 5 illustrates an exploded plan view of an example of a cart member according to various embodiments described herein.

FIG. 6 shows a perspective view of an example of a cart member according to various embodiments described herein.

FIG. 7 depicts a close-up perspective view of a portion of the cart member showing an example of a pivotal coupling according to various embodiments described herein.

FIG. 8 illustrates an elevation view of an example of a cart member in a first orientation according to various embodiments described herein.

FIG. 9 shows a perspective view of an example of a cart member in a second orientation according to various embodiments described herein.

FIG. 10 depicts a perspective view of an example of a convertible cart and elevated stand apparatus in a cart configuration with a first obtuse angle orientation according to various embodiments described herein.

FIG. 11 illustrates an elevation view of an example of a convertible cart and elevated stand apparatus in a cart configuration with a second acute angle orientation according to various embodiments described herein.

FIG. 12 shows an elevation view of an example of a convertible cart and elevated stand apparatus in a cart configuration with a co-planar obtuse angle orientation according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New hunting and transportation apparatuses are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

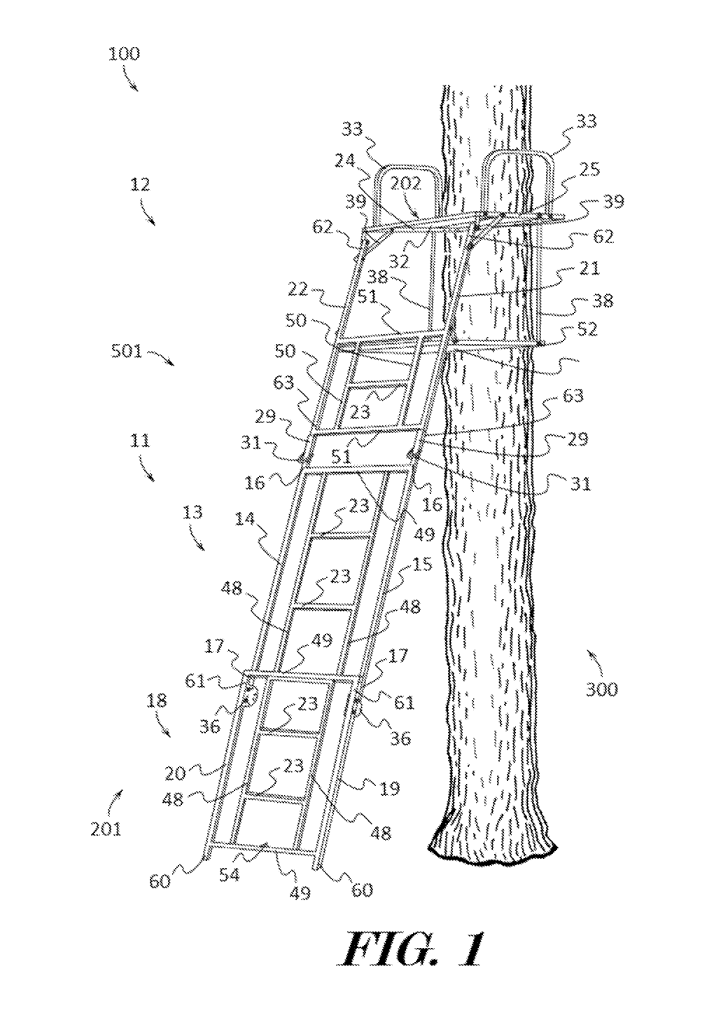

The present invention will now be described by example and through referencing the appended figures representing preferred and alternative embodiments. FIG. 1 illustrates an example of a convertible cart and elevated stand apparatus (“the apparatus”) 100 in an elevated stand configuration 201 against a tree trunk 300 according to various embodiments. In this example, the apparatus 100 comprises a cart member 11 and a stand member 12 which are adapted to be removably coupled to each other to form an elevated stand 202 suitable for supporting the weight of an individual. In some embodiments, a cart member 11 may include a first frame section 13 which may comprise a first pair of cart longitudinal support bars 14, 15 each having a distal end 16 and a proximal end 17 with each of the distal ends 16 adapted to be removably coupled to a stand member 12. The cart member 11 may further include a second frame section 18 which may comprise a second pair of cart longitudinal support bars 19, 20 each having a distal end 60 and a proximal end 61 with each of the proximal ends 61 pivotally coupled to the proximal ends 17 of the first pair of longitudinal support bars 14, 15 of the first frame section 13.

In some embodiments, a stand member 12 may include a pair of stand longitudinal support bars 21, 22 each having a distal end 62 and a proximal end 63 with the proximal ends 63 configured to be removably coupled with the distal ends 16 of the first pair of cart longitudinal support bars 14, 15 of the first frame section 13. The pairs of cart longitudinal support bars 14, 15, 19, and 20, and stand longitudinal support bars 21, 22, may each support one or more such as a plurality of transverse rails 23 preferably spaced apart as on conventional ladders and configured to be used as ladder rungs. The stand member 12 may further include a pair of upper platform support bars 24, 25, that may be rotatably coupled to the distal ends 62, of the stand longitudinal support bars 21, 22, and a pair of lower platform support bars 26, 27, that may be coupled to the stand member 12 proximate to a location between the distal ends 62 and proximate ends 63 of the stand longitudinal support bars 21, 22, with the pair of lower platform support bars 26, 27, configured to support the weight of the lower platform 28 and with the upper platform support bars 24, 25 configured to support a seat 34.

In some embodiments, one or more of the elements that comprise the apparatus 100 may be made from a lightweight and rigid material such as round or square tubing aluminum tubing, lightweight steel tubing, other metal alloy tubing, plastic tubing, and the like which may or may not be hollow. In further embodiments, one or more braces such as cart longitudinal braces 48, cart latitudinal braces 49, stand longitudinal braces 50, and/or stand latitudinal braces 51 may be made from round or square tubing may be welded or otherwise coupled to other elements of the apparatus 100.

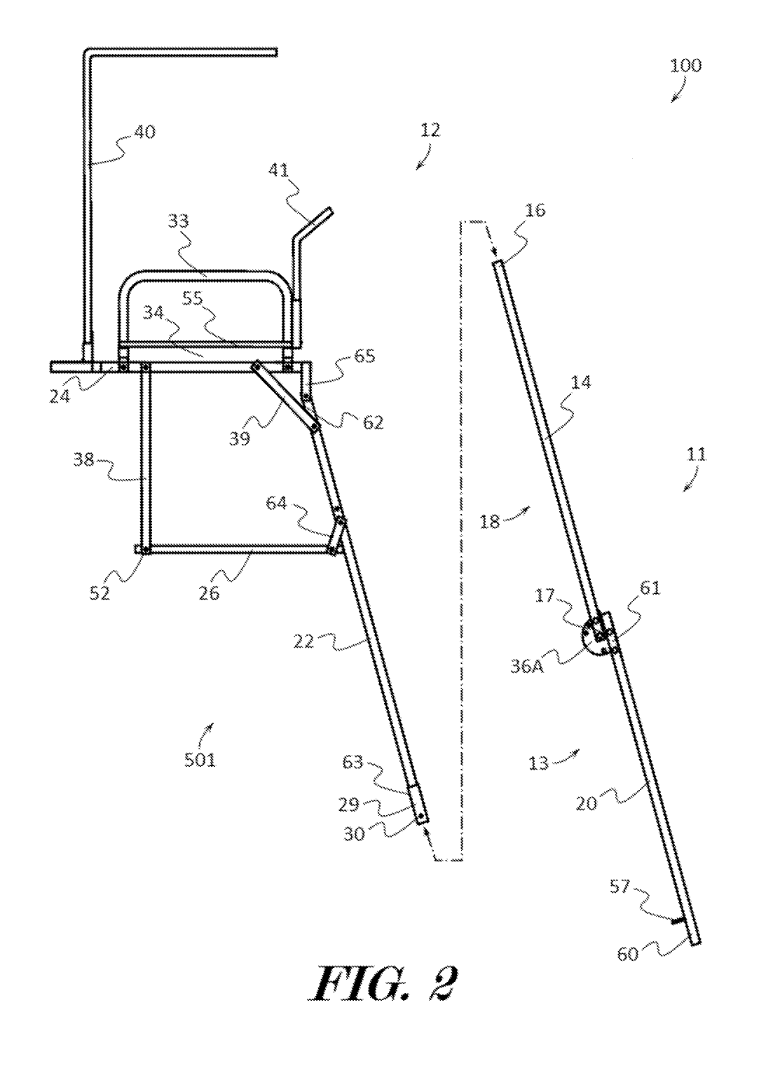

FIG. 2 illustrates a side elevation view of an example of a convertible cart and elevated stand apparatus 100 according to various embodiments described herein. The cart member 11 may be temporarily coupled the stand member 12 by temporarily coupling the distal ends 16 of the first pair of longitudinal support bars 14, 15 to the proximal ends 63 of the pair of stand longitudinal support bars 21, 22. In some embodiments, elements of the apparatus 100 may be removably coupled so that a portion of one element may be inserted into a portion of another element such as a coupling sleeve 29 with the two elements being frictionally secured together. In further embodiments, elements of the apparatus 100 may be removably coupled so that a portion of one element comprising an aperture such as a pin aperture 30 may be inserted into a portion of another element such as a coupling sleeve 29 also comprising a pin aperture 30 and the two elements may be secured together by inserting a fastener such as a locking pin 31, bolt type fastener, screw type fastener, cotter pin, and the like through the pin apertures 30. In further embodiments, elements of the apparatus 100 may each comprise a pin aperture 30 so that when a portion of an element comprising a pin aperture 30 is placed proximate to another portion of an element comprising a pin aperture 30, a fastener such as a threaded knob 52, locking pin 31, nut type fastener 37 and bolt type fastener 47, washer 58, screw type fastener, cotter pin, and the like may be inserted, optionally temporarily inserted, through the pin apertures 30 so that the two elements may be rotatably and/or removably coupled to each other.

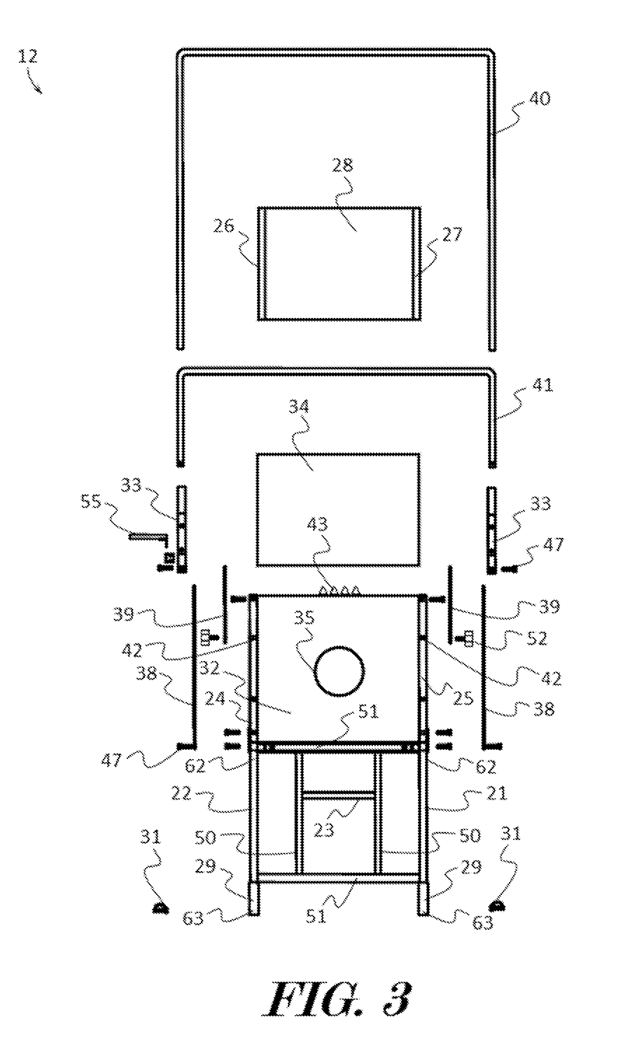

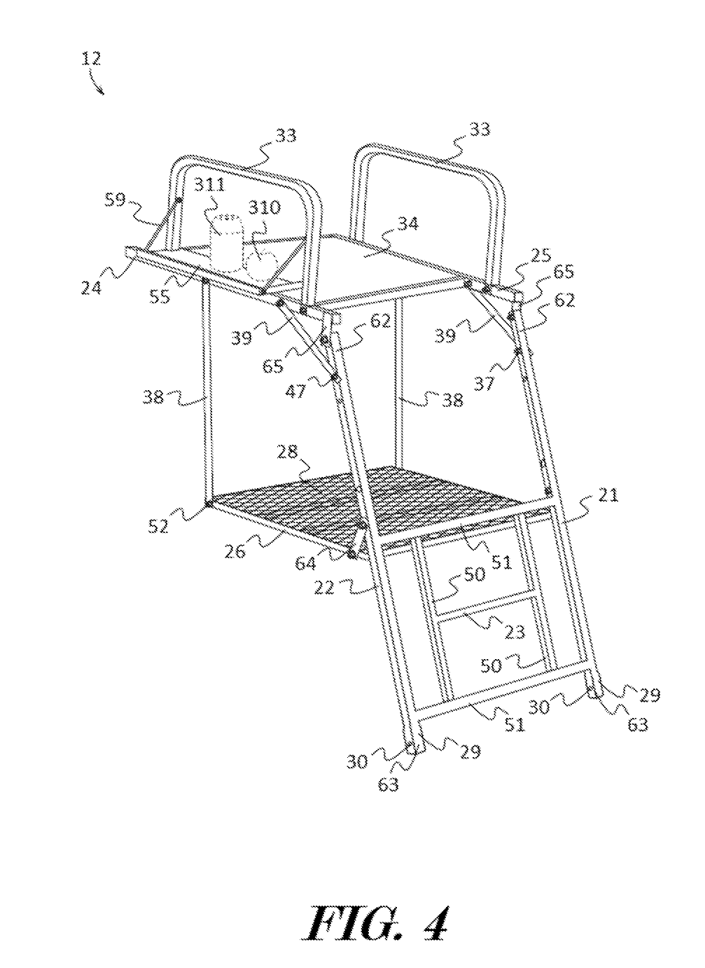

Turning now to FIG. 3, which shows an exploded plan view of an example of a stand member 12 and FIG. 4 which depicts a perspective view of an example of a stand member 12 according to various embodiments described herein, in some embodiments and in the present example, the apparatus 100 (FIGS. 1, 2, 8, 9, 10) may comprise a stand member 12, which may include a pair of stand longitudinal support bars 21, 22, each having a distal end 62 and a proximal end 63 and one or more transverse rails 23 positioned between the pair of stand longitudinal support bars 21, 22, with a transverse rail 23 configured to be used as a ladder rung. The stand member 12 may also include a pair of upper platform support bars 24, 25, which may be rotatably coupled to the distal ends 62 of the stand longitudinal support bars 21, 22, and which may be coupled to and/or support a seat 34. Optionally, an upper platform support bar 24, 25, may be coupled to a bar extension 65 configured to extend away from the platform support bar 24, 25 and which may be rotatably coupled to the distal end 62 of a stand longitudinal support bar 21, 22, to facilitate the range of motion of the rotational coupling. In some embodiments, the seat 34 may be rotatably coupled to one or more of the upper platform support bars 24, 25. In further embodiments, the seat 34 may be coupled to a rotatable coupling such as a ball bearing swivel 35 or other suitable device and the rotatable coupling such as a ball bearing swivel 35 may also be coupled to one or more of the upper platform support bars 24, 25, allowing the seat to pivot or rotate relative to the upper platform support bars 24, 25.

The stand member 12 may also include a pair of lower platform support bars 26, 27, which may be rotatably coupled and/or removably coupled to the pair of stand longitudinal support bars 21, 22, and which may support a lower platform 28. A lower platform 28 may be generally planar in shape and configured to provide a surface suitable for supporting the feet of a user or other items placed on it. One or more lower platform braces 64 may pivotally and/or removably couple a lower platform support bar 26, 27, to a stand longitudinal support bar 21, 22. In some embodiments, each lower platform support bar 26, 27 may be removably or rotatably coupled to a stand longitudinal support bars 21, 22, with a threaded knob fastener 52, a locking pin 31, or any other suitable coupling method.

In some embodiments, a lower platform support bar 26, 27, and a stand longitudinal support bar 21, 22, may each comprise a pin aperture 30 so that when a portion of a lower platform support bar 26, 27, is placed proximate to a stand longitudinal support bar 21, 22, a fastener such as a locking pin 31, nut type fastener 37 and bolt type fastener 47, washer 58, screw type fastener, cotter pin, and the like may be inserted, optionally temporarily inserted, through the pin apertures 30 so that the lower platform support bar 26, 27, and stand longitudinal support bar 21, 22 may rotate relative to each other while remaining coupled, optionally temporarily coupled, together.

In some embodiments, the pair of lower platform support bars 26, 27, may be removably coupled and/or rotatably coupled to the upper platform support bars 24, 25, through a major support brace 38 and a locking pin 31, nut fastener 37, bolt fastener 28, or any other suitable fastener. In other embodiments, each lower platform support bar 26, 27, may be removably coupled and/or rotatably coupled to an upper platform support bars 24, 25, through a major support brace 38 and a threaded knob 52. A threaded knob 52 or other fastener may removably couple two or more elements such as a major support brace 38 to a lower platform support bar 26, 27 and be configured to facilitate coupling without the use of tools. A lower platform support bar 26 and an upper platform support bar 24 may each comprise a pin aperture 30, while a major support brace 38 may comprise two pin apertures 30. A first pin aperture 30 of the major support brace 38 may be placed proximate to the pin aperture 30 of the of the lower platform support bar 26 and a fastener such as a locking pin 31, bolt type fastener, screw type fastener, cotter pin, and the like may be inserted, optionally temporarily inserted, through the pin apertures 30. Similarly, a first pin aperture 30 of the major support brace 38 may be placed proximate to the pin aperture 30 of the of the upper platform support bar 24 and a fastener such as a locking pin 31, bolt type fastener, screw type fastener, cotter pin, and the like may be inserted, optionally temporarily inserted through the pin apertures 30. In this manner, the locking pins 31 and the major support brace 38 may be configured to removably couple and/or rotatably couple the lower platform support bar 26 to the upper platform support bar 24. Likewise, locking pins 31 and another major support brace 38 may be configured to removably couple and/or rotatably couple the lower platform support bar 27 to the upper platform support bar 25.

In some embodiments, the upper platform support bars 24, 25, may be removably coupled and/or rotatably coupled to the distal ends 62 of the stand longitudinal support bars 21, 22, with a minor support brace 39 and a locking pin 31. An upper platform support bar 24 and a distal end 62 of a stand longitudinal support bar 22 may each comprise a pin aperture 30, while a minor support brace 39 may comprise two pin apertures 30. A first pin aperture 30 of the minor support brace 39 may be placed proximate to the pin aperture 30 of the of the upper platform support bar 24 and a fastener such as a locking pin 31, bolt type fastener, screw type fastener, cotter pin, and the like may be inserted, optionally temporarily inserted, through the pin apertures 30. Similarly, a first pin aperture 30 of the minor support brace 39 may be placed proximate to the pin aperture 30 of the distal end 62 of a stand longitudinal support bar 22 and a fastener such as a locking pin 31, bolt type fastener, screw type fastener, cotter pin, and the like may be inserted, optionally temporarily inserted through the pin apertures 30. In this manner, the locking pins 31 and the minor support brace 39 may be configured to removably couple and/or rotatably couple the upper platform support bar 24 to the distal end 62 of the stand longitudinal support bar 22. Likewise, locking pins 31 and another minor support brace 39 may be configured to removably couple and/or rotatably couple the upper platform support bar 25 to the distal end 62 of the stand longitudinal support bars 21.

As shown in FIGS. 1, 3, and 4, in some embodiments, the apparatus 100 may comprise a platform support board 32 which may be coupled to portions of a stand member 12 such as to one or more upper platform support bars 24, 25. A platform support board 32 may be generally planar in shape and be configured to provide a surface suitable for supporting the weight of an individual and other objects. In further embodiments, a platform support board 32 may be coupled to a rotatable coupling such as a ball bearing swivel 35 and coupled to one or more upper platform support bars 24, 25. A seat 34 may be coupled to the rotatable coupling 35 such as a ball bearing swivel 35A thereby allowing the seat 34 to be rotatably coupled to one or more upper platform support bars 24, 25

Referencing FIGS. 1-4, in some embodiments, the apparatus 100 may comprise one or more optional arm rests 33 which may be removably coupled to portions of a stand member 12 such as one or more upper platform support bars 24, 25 and/or a platform support board 32. Portions of an arm rest 33 may be removably coupled to a stand member 12 while another portion of the arm rest 33 configured to extend away from the stand member 12 to support the arm of an individual that may be sitting or standing on the elevated stand 202 of the stand member 12. In further embodiments, the apparatus 100 may comprise an arm rest 33 coupled to the stand member 12 and positioned above and adjacent to the seat 34.

In some embodiments, a stand member 12 may comprise a utility tray 55 (FIGS. 3 and 4). A utility tray 55 may be coupled or removably coupled to an arm rest 33, a platform support board 32, and/or an upper platform support bar 24, 25. The utility tray 55 may be configured to support items within reach of an individual seated on the stand member 12 such as food items 310 (FIG. 4), drink items 311 (FIG. 4), cellular phone, or any other similar item or items. Optionally, one or more tray braces 59 may be pivotally and/or removably coupled to the utility tray 55 and an arm rest 33, a platform support board 32, and/or an upper platform support bar 24, 25 to further support the weight of items on the utility tray 55. In further embodiments, a stand member 12 may comprise a pair of arm rests 33 removably coupled to the pair of upper platform support bars 24, 25, with one of the of arm rests 33 coupled to and supporting a removable utility tray 55.

In further embodiments, the apparatus 100 may comprise a canopy frame 40 and/or a restraining bar 41 which may be removably coupled to portions of a stand member 12 such as one or more upper platform support bars 24, 25 and/or a platform support board 32. Portions of a canopy frame 40 may be removably coupled to a stand member 12 such as by inserting portions of the canopy frame 40 into portions of the stand member 12 while another portion of the canopy frame 40 configured to extend away from the stand member 12 to support a canopy to provide protection from the sun, rain and other elements to an individual sitting or standing on the elevated stand 202 of the stand member 12. In some embodiments, the apparatus may comprise one or more such as a pair of anchor pegs 42 which may be positioned on each of the upper platform support bars 24, 25. The anchor pegs 42 may be configured to removably secure or removably connect portions of a canopy frame 40 to the stand member 12 such as by inserting the anchor pegs 42 into portions of the canopy frame 40 or by inserting portions of the canopy frame 40 into the anchor pegs 42. Portions of a restraining bar 41 may be removably coupled to a stand member 12 such as by inserting portions of a restraining bar 41 into portions of the stand member 12 while another portion of the restraining bar 41 configured to extend away from the stand member 12 to support the arms and/or firearm of an individual and optionally prevent the individual from falling off the apparatus 100 while sitting or standing on the elevated stand 202 of the stand member 12.

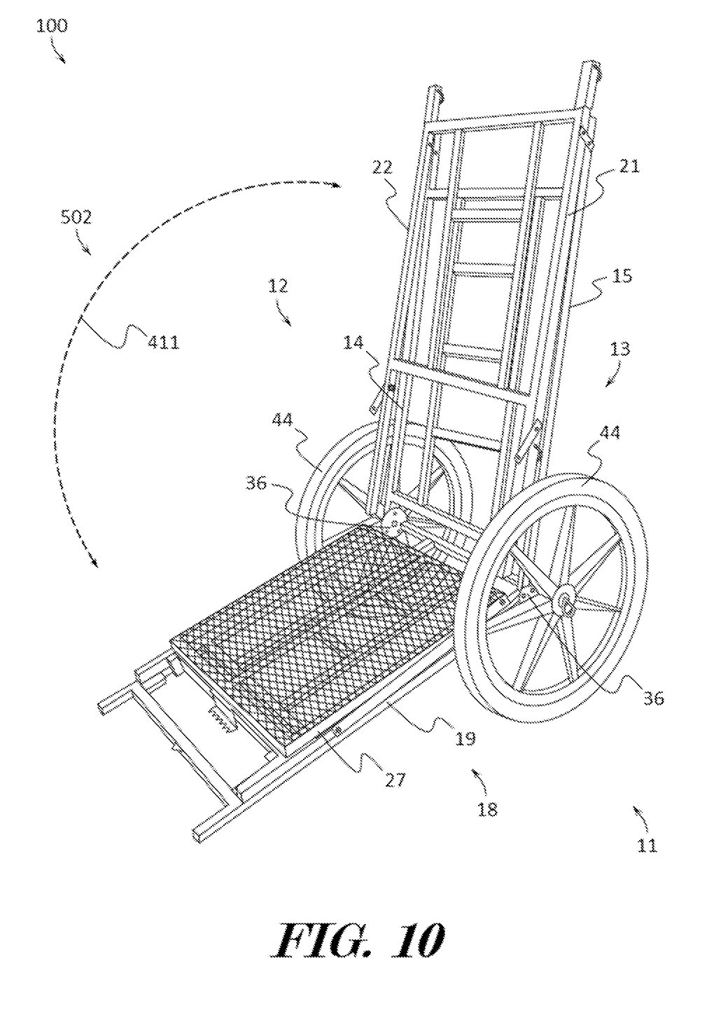

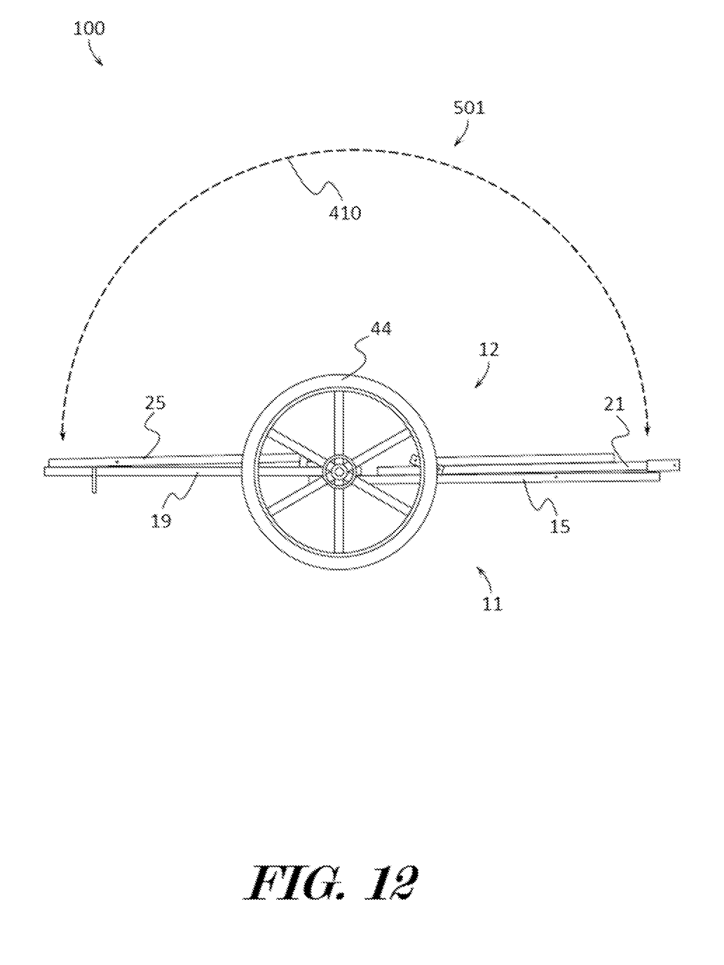

In further embodiments, the stand member 12 may comprise one or more anchor pegs 42 which may be positioned on or coupled to one or more stand latitudinal braces 50, upper platform support bars 24, 25, stand longitudinal support bars 21, 22, and/or a platform support board 32. An anchor peg 42 may engage with portions of a cart member 12 such as one or more transverse rails 23, cart latitudinal braces 49, or other element of the cart member 11 once the stand member 12 is received on the cart member 11 as in cart configuration 210 (FIGS. 10-12). Portions of an anchor peg 42 may contact, be inserted into, or otherwise temporarily engage portions of the cart member 11 to prevent the stand member 12 from sliding off of the cart member 11 during transport.

As perhaps best shown in FIG. 4, in some embodiments, the stand member 12 may comprise one or more tree spikes 43. A tree spike 43 may be coupled to the stand member 12 such as to one or more upper platform support bars 24, 25, a platform support board 32, and/or on any other element of a stand member 12 and configured to contact portions of a tree 300 (FIG. 1) against which the apparatus 100 in the elevated stand configuration 201 (FIG. 1) may be leaned against. In further embodiments, the stand member 12 may comprise a tree strap 56 which may be coupled to the stand member 12 preferably proximate to a tree spike 43. A tree strap 56 may be positioned around the trunk of a tree (FIG. 1) and tightened by hand or by a strap tightening device such as a conventional ratchet type strap tightening device. A tree spike 43 may be generally pointed in shape and configured to pierce or embed within the exterior of the tree 300 to increase the frictional resistance of the portions of the stand member 23 contacting the tree 300.

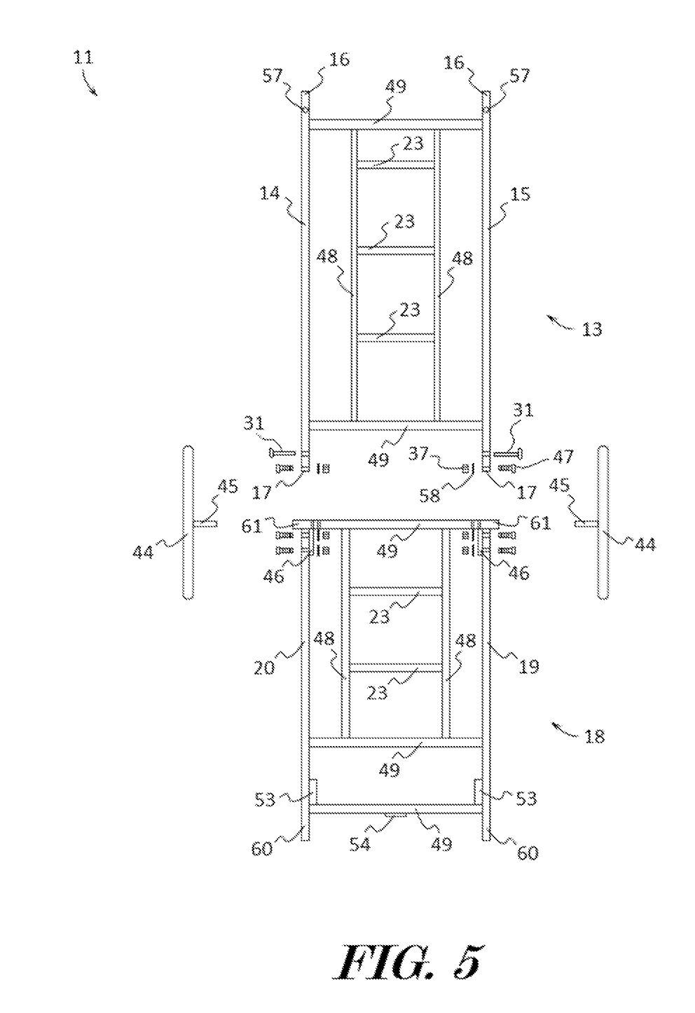

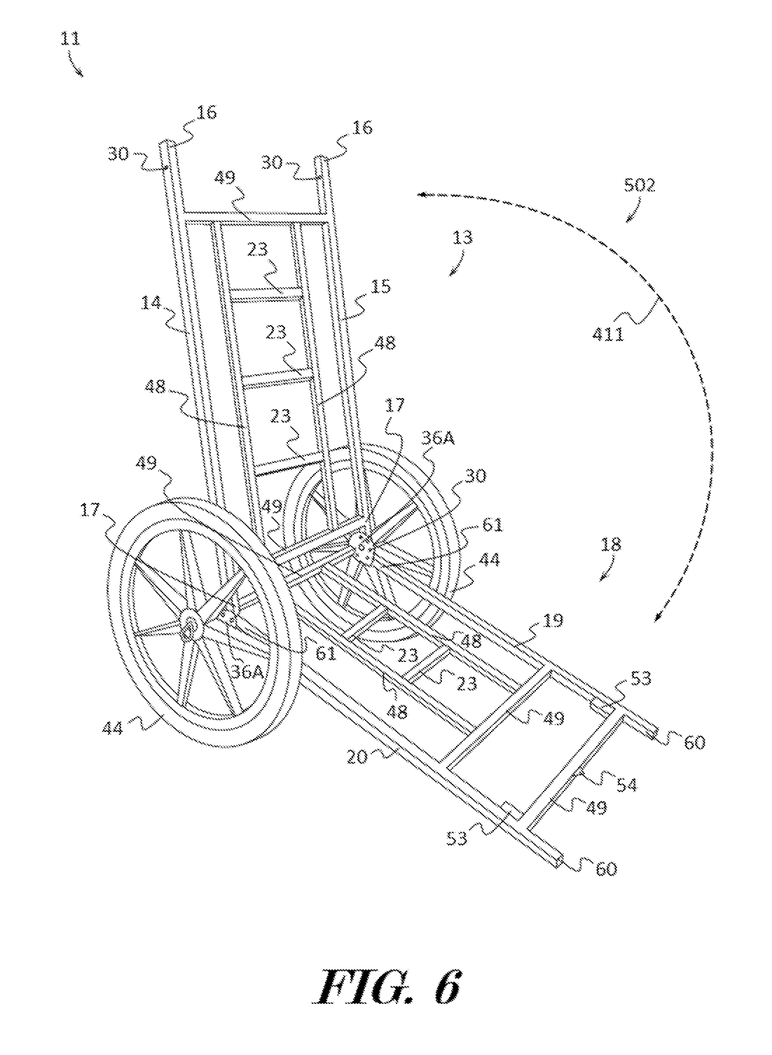

Referring now to FIG. 5 which illustrates an exploded plan view of an example of a cart member 11 and FIG. 6 which shows a perspective view of an example of a cart member 11 according to various embodiments described herein, in some embodiments, a cart and elevated stand apparatus 100 may comprise a cart member 11 that includes a first frame section 13 and second frame section 18 which are configured to pivotally rotate relative to each other and be secured into one or more fixed orientations. The first frame section 13 may comprise a first pair of longitudinal support bars 14, 15, each having a distal end 16 and a proximal end 17 with one or more transverse rails 23 positioned between the first pair of longitudinal support bars 14, 15. The second frame section 18 may comprise second pair of cart longitudinal support bars 19, 20, each having a distal end 60 and a proximal end 61 and one or more transverse rails 23 positioned between the second pair of cart longitudinal support bars 19, 20. One or more pivotal couplings 36 such as a locking hinge 36A may be configured to pivotally couple the first frame section 13 to the second frame section 18 allowing the frame sections 13, 18, to pivotally rotate relative to each other and be secured to into one or more fixed orientations.

As shown in FIGS. 5-7, the cart member 11 may be configured to removably couple a first wheel 44 and a second wheel 44 which may be configured to facilitate the movement of the cart member 11 while in the cart configuration 210 (FIG. 5). In some embodiments, the apparatus 100 may comprise a first wheel 44 and a second wheel 44 each removably coupled to opposite sides of the cart member 11 and each proximate to a pivotal coupling 36. In some embodiments, a wheel may comprise an axle 45 which may be inserted into portions of the cart member 11. The axle 45 and the portion of the cart member 11 into which the axle 45 may be inserted may each comprise one or more pin apertures 30, and by inserting a locking pin 31 through the pin apertures 30, the wheel 44 may be removably coupled to the cart member 11.

In some embodiments, a cart member 11 may comprise one or more attachment points 54 (FIG. 6) and configured to receive and secure a safety strap. An attachment point 54 may be may be positioned on or coupled to one or more cart latitudinal braces 48, longitudinal support bars 14, 15, 19, 20, and/or transverse rails 23. One or more straps such as a length of nylon webbing, rope, chain, or other flexible material may be engaged with or secured around portions of a attachment point 54 and also engaged with or secured around portions of a tree 300. By tying, coupling together with a fastener such as Velcro®, or other suitable connection method, an attachment point 54 may be used to temporarily secure portions of a cart member 11 to a tree 300 with a strap or other flexible material while the apparatus 100 is in an elevated stand configuration 201 (FIG. 1). Optionally, a strap or other flexible material that may be tied, coupled with a fastener, or other connection method to portions of a stand member 12 and an attachment point 54 when the apparatus 100 is in a cart configuration 210, to secure the stand member 12 to the cart member 11 during transport.

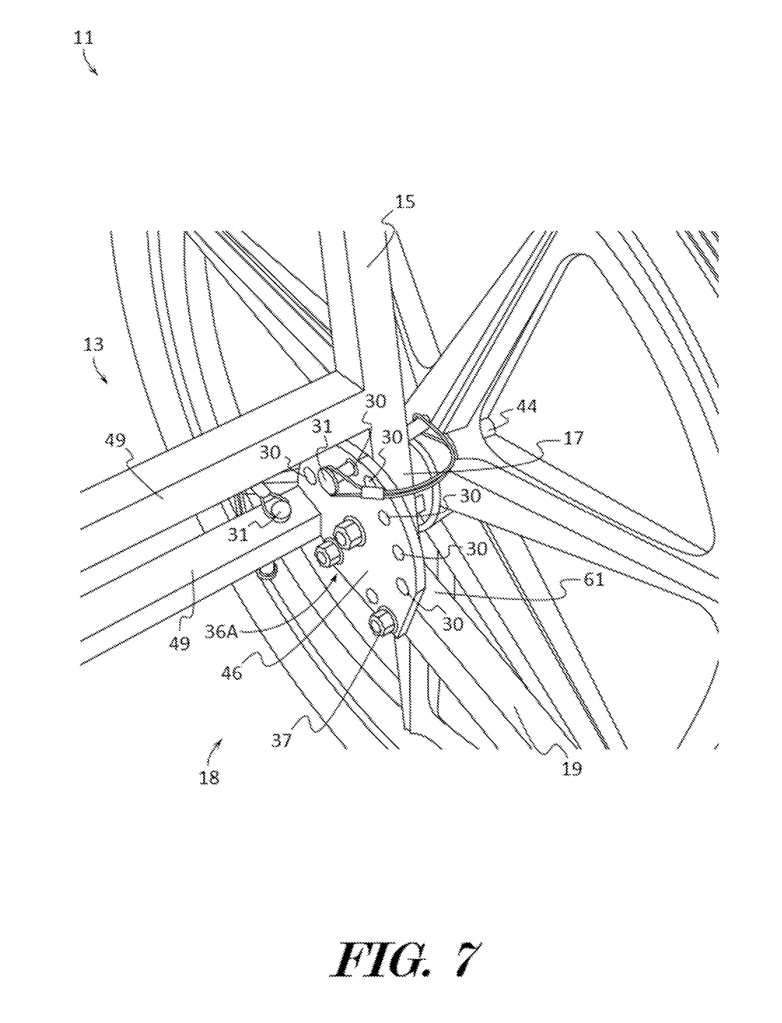

As perhaps best shown in FIG. 7, one or more elements of the apparatus 100 may be removably coupled to one or more other elements with a locking pin 31 which may be inserted through one or more pin apertures 30 thereby securing the elements together. In some embodiments, a locking pin 31 may comprise a snapper pin, as shown, which generally consists of a pin with a hand-deformable, tempered, spring steel wire that slips over the end of the pin. In other embodiments, a locking pin 31 may comprise a hitch pin with a detent locking mechanism, a hitch pin with a cotter pin attached via chain to prevent misplacement, a hitch pin held in place by a safety spring pin, a linch pin (also linchpin, lynch pin, and click pin) employing a locking ring into the pin design that fastens the pin in place, a clevis pin, a detent pin containing a hallowed section of the pin with a perpendicular spring that extrudes one or two ball bearings from the pin's shaft, a toggle pin with a locking mechanism is a hinged device that prevents the pin from being withdrawn until the lock is aligned with the pin by hand, or any other suitable pin configured to prevent inadvertent removal of the pin from an aperture.

Also in referencing FIG. 7, in some embodiments, the first frame section 13 of the cart member 11 may be pivotally coupled to the second frame section 18 of the cart member 11 through a pivotal coupling 36 such as a locking hinge 36A. A locking hinge 36A may comprise a locking plate 46 which may be coupled to a frame section such as to a proximal end 17 of a longitudinal support bar 19 of the second frame section 18, and the locking hinge 36A may comprise a locking pin 31 engaged within a pin aperture 30 positioned on the locking plate 46. Optionally, the locking plate 46 may be coupled to a frame section such as the second frame section 18 with one or more nut fasteners 37 and bolt fasteners 47, heat bonding, or any other suitable coupling method. The other frame section such as the proximal end 17 of the longitudinal support bar 15 of a first frame section 13 may be pivotally coupled to the locking plate 46 such as with a nut fastener 37 and bolt fastener 47 which may extend through the locking plate 46 and the first frame section 13. The locking plate 46 and the first frame section 13 may also comprise one or more pin apertures 30. By pivoting the first frame section 13 relative to the locking plate 46, a pin aperture 30 of the first frame section 13 may be aligned with various pin apertures 30 on the locking plate 46 allowing a locking pin 31 to be inserted or engaged into the aligned pin apertures 30 thereby allowing the frame sections 13, 18, to pivotally rotate relative to each other and be temporarily secured to into one or more fixed orientations. In further embodiments, the locking plate 46 may comprise a plurality such as three or more pin apertures 30 arranged in a semi-circular orientation as shown in FIG. 7.

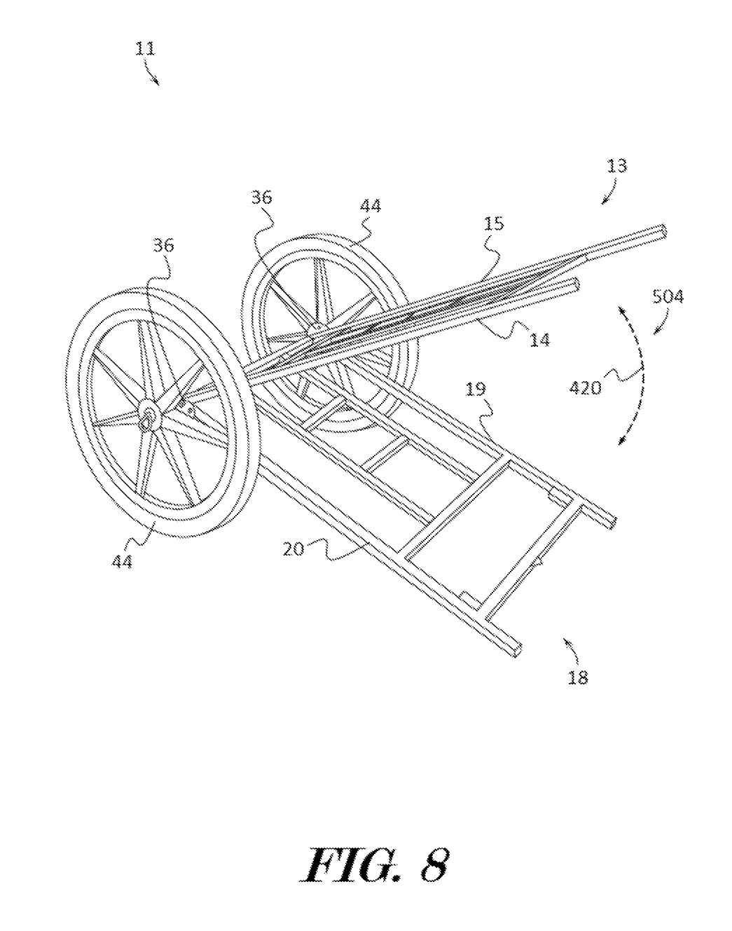

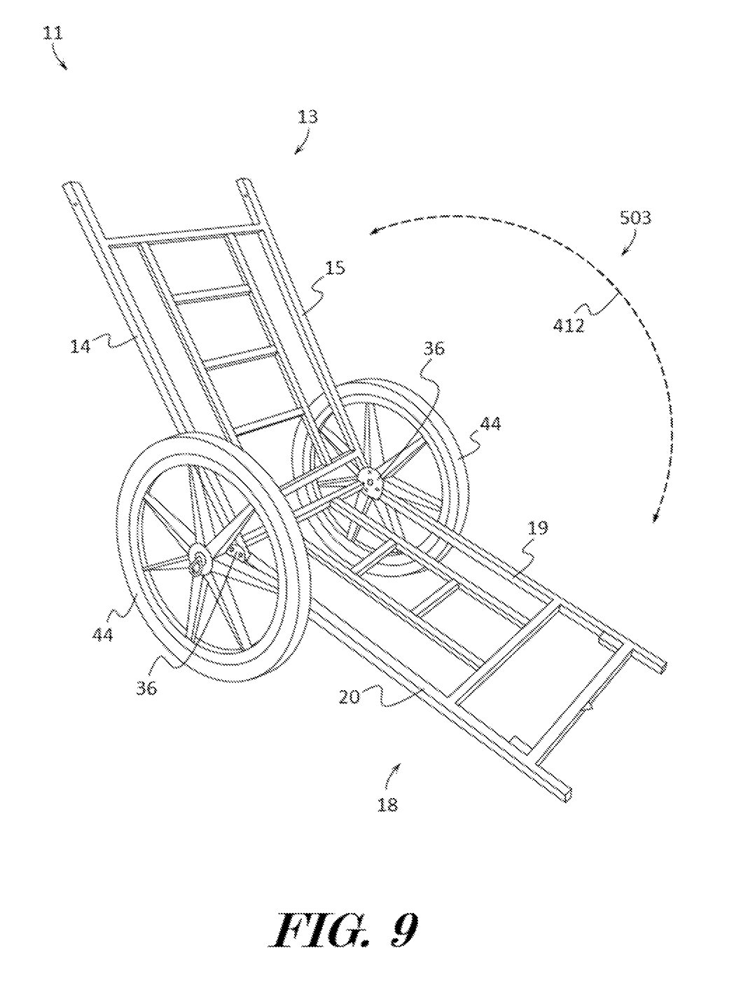

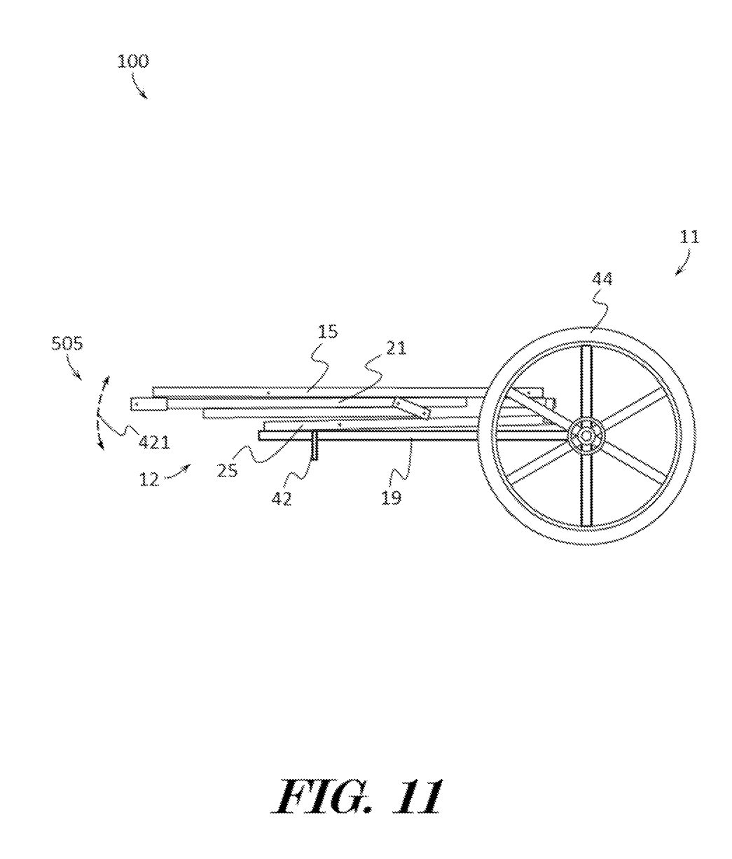

The apparatus 100 may be arranged in an elevated stand configuration 201 (FIG. 1) and in a cart configuration 210 (FIGS. 10-12). In some embodiments, the apparatus 100 may be arranged in a cart configuration 210 by uncoupling the cart member 11 from the stand member 12 and coupling the wheels 44 to opposite sides of the cart member 11 proximate to a pivotal coupling 36. The first frame section 13 may be pivotally rotated relative to the second frame section 18 through a pair of pivotal couplings 36 and temporarily secured in to a plurality of fixed orientations with a locking pin 31 engaged with each of the pivotal couplings 36. Many fixed orientations of the cart member 11 and stand member 12 when in a cart configuration 210 may be achieved by the pivotal couplings 36 such as a substantially obtuse co-planar fixed orientation 501 (FIGS. 1, 2, and 12), a first obtuse fixed orientation 502 (FIGS. 6 and 10), a second obtuse fixed orientation 503 (FIG. 9), a first acute fixed orientation 504 (FIG. 8), a second acute fixed orientation 505 (FIG. 11), or any other angular fixed orientation. In further embodiments, a cart member's 11 first frame section 13 and second frame section 18 may be configured to be repositioned relative to each other in one of a first orientation, a second orientation, and a third orientation by inserting a locking pin 31 of a pivotal coupling 36 into a first pin aperture 30, a second pin aperture 30, or a third pin aperture 30 on a locking plate 46 and into a pin aperture 30 on the first frame section 13.

In some embodiments, a cart member's first frame section 13 and second frame section 18 may be repositioned relative to each other in a substantially obtuse co-planar fixed orientation (FIGS. 1, 2, and 12) so that the first frame section 13 is at a generally 180 degree obtuse angle 410 relative to the second frame section 18. In some embodiments, a cart member's first frame section 13 and second frame section 18 may be repositioned relative to each other in a first obtuse fixed orientation (FIGS. 6 and 10) so that the first frame section 13 is at a generally 91-120 degree first obtuse angle 411 relative to the second frame section 18. In some embodiments, a cart member's first frame section 13 and second frame section 18 may be repositioned relative to each other in a second obtuse fixed orientation (FIG. 9) so that the first frame section 13 is at a generally 121-179 degree second obtuse angle 412 relative to the second frame section 18. In some embodiments, a cart member's first frame section 13 and second frame section 18 may be repositioned relative to each other in a first acute fixed orientation (FIG. 8) so that the first frame section 13 is at a generally 10-89 degree first acute angle 420 relative to the second frame section 18. In some embodiments, a cart member's first frame section 13 and second frame section 18 may be repositioned relative to each other in a second acute fixed orientation (FIG. 11) so that the first frame section 13 is at a generally 1-9 degree second acute angle 421 relative to the second frame section 18. In some embodiments, a cart member's first frame section 13 and second frame section 18 may be repositioned relative to each other in a generally right angle fixed orientation so that the first frame section 13 is at a generally 90 degree angle relative to the second frame section 18.

As shown in FIGS. 10, 11, and 12, the cart member 11 may receive and support the stand member 12 when the apparatus 100 is configured in the cart configuration 210. The pivotal and/or removable couplings of the elements of the stand member 12 may allow the stand member 12 to be folded or disassembled into a compact configuration. When in the cart configuration 210 items such as outdoor equipment, food supplies, firearms, animal carcasses, and the like may be placed onto the apparatus for transport across various terrains. Also by repositioning the cart member's 11 first frame section 13 and second frame section 18 relative to each other in one of a first orientation, a second orientation, and a third orientation the center of gravity of the items placed on the apparatus 100 may be changed to prevent the apparatus 100 from becoming unwieldy and hindering the ability of an individual to move the loaded apparatus 100.

In some embodiments, the cart member 11 may comprise one or more slide stops 53 (FIG. 6) which may be positioned on or coupled to one or more cart latitudinal braces 48, longitudinal support bars 14, 15, 19, 20, and/or transverse rails 23. A slide stop 53 may engage with portions of a stand member 12 such as one or more anchor pegs 42 (FIGS. 3 and 11) once the stand member is received on the cart member 11 as in cart configuration 210 (FIGS. 10-12). Portions of the stand member 12 such as one or more anchor pegs 42 may contact, be inserted into, or otherwise temporarily engage with a slide stop 52 to prevent the stand member 12 from sliding off of the cart member 11 during transport.

In further embodiments, the cart member 11 may comprise one or more restraining pegs 57 (FIG. 2) which may be positioned on or coupled to one or more cart latitudinal braces 48, longitudinal support bars 14, 15, 19, 20, and/or transverse rails 23. A restraining peg 57 may engage with portions of a stand member 12 such as one or more transverse rails 23, stand latitudinal braces 50, or other element of the stand member 12 once the stand member is received on the cart member 11 as in cart configuration 210 (FIGS. 10-12). Portions of a restraining pegs 57 may contact, be inserted into, or otherwise temporarily engage portions of the stand member 12 to prevent the stand member 12 from sliding off of the cart member 11 during transport.

The elements that comprise the apparatus 100 may be made from durable materials such as metal alloys, hard plastics, wood, hard rubbers, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the apparatus 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the apparatus 100 may be removably coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the apparatus 100 may be coupled by being one of connected to and integrally formed with another element of the apparatus 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A convertible cart and elevated stand apparatus, the apparatus comprising;
a. a cart member comprising;
i. a first frame section comprising a first pair of cart longitudinal support bars each having a distal end and a proximal end with each of said distal ends adapted to be removably coupled to a stand member,
ii. a second frame section comprising a second pair of cart longitudinal support bars each having a distal end and a proximal end with each of said proximal ends pivotally coupled to the proximal ends of the pair of longitudinal support bars of the first frame section; and
b. a stand member comprising;
i. a pair of stand longitudinal support bars each having a distal end and a proximal end with the proximal ends configured to be removably coupled with the distal ends of the first pair of cart longitudinal support bars of the first frame section, said first pair of cart longitudinal support bars and the pair of stand longitudinal support bars each supporting a plurality of transverse rails configured to be used as rungs on a ladder, and
ii. a pair of upper platform support bars rotatably coupled to the distal ends of the pair of stand longitudinal support bars and a pair of lower platform support bars coupled to a location between said stand longitudinal support bars distal ends and proximate ends with said pair of lower platform support bars configured to support the weight of the lower platform and with said upper platform support bars configured to support a seat;
wherein the cart member and stand member are adapted to be removably coupled to each other to form an elevated stand.

2. The apparatus of claim 1, wherein the first frame section of the cart member is pivotally coupled to the second frame section of the cart member through a locking hinge.

3. The apparatus of claim 2 wherein the locking hinge comprises a locking pin engaged within a pin aperture positioned on a locking plate.

4. The apparatus of claim 3, wherein the locking plate comprises a plurality of pin apertures arranged in a semi-circular orientation.

5. The apparatus of claim 1, further comprising a seat coupled to the upper platform support bars.

6. The apparatus of claim 5, where the seat is rotatably coupled to the upper platform support bars.

7. The apparatus of claim 5, further comprising an arm rest coupled to the stand member and positioned above and adjacent to the seat.

8. The apparatus of claim 1, wherein the cart member is configured to be uncoupled from the stand member and arranged in a cart configuration where the first frame section is adapted to rotate relative to the second frame section through a pair of pivotal couplings and secured in to a fixed orientation with a locking pin engaged with each of the pivotal couplings.

9. The apparatus of claim 1, further comprising a pair of arm rests removably coupled to the pair of upper platform support bars with one of said pair of arm rests supporting a removable utility tray.

10. The apparatus of claim 1, further comprising a canopy frame removably connected to the stand member with an anchor peg.

11. A cart and elevated stand apparatus comprising a cart member, said cart member comprising a first frame section pivotally coupled to a second frame section,
a. said first frame section comprising a pair of cart longitudinal support bars each having a distal end and a proximal end and a transverse rail positioned between the pair of cart longitudinal support bars;
b. said second frame section comprising a pair of cart longitudinal support bars each having a distal end and a proximal end and a transverse rail positioned between the pair of cart longitudinal support bars;
wherein the first frame section and second frame section are configured to pivotally rotate relative to each other and be secured to into a fixed orientation with a locking hinge.

12. The apparatus of claim 11, wherein the cart member's first frame section and second frame section are configured to be repositioned relative to each other in one of a first orientation, a second orientation, and a third orientation.

13. The apparatus of claim 11 wherein the locking hinge comprises a locking pin engaged within a pin aperture positioned on a locking plate.

14. The apparatus of claim 13, wherein the locking plate comprises a plurality of pin apertures arranged in a substantially semi-circular orientation.

15. The apparatus of claim 11, further comprising a first wheel and a second wheel removably coupled to opposite sides of the cart member at the proximal ends of the cart longitudinal support bars of the first and second frame sections.

16. A cart and elevated stand apparatus, the apparatus comprising an stand member comprising:
a. a pair of stand longitudinal support bars each having a distal end and a proximal end and a transverse rail positioned between the pair of stand longitudinal support bars with said transverse rail configured to be used as a ladder rung;
b. a pair of upper platform support bars rotatably coupled to the distal ends of the stand longitudinal support bars, said pair of upper platform support bars supporting a seat;
c. a pair of lower platform support bars rotatably coupled to the pair of stand longitudinal support bars with said pair of lower platform support bars supporting a stand platform.

17. The apparatus of claim 16, wherein the pair of lower platform support bars are removably coupled to the upper platform support bars through a major support brace and a locking pin.

18. The apparatus of claim 16, wherein the upper platform support bars are removably coupled to the distal ends of the stand longitudinal support bars with a minor support brace and a locking pin.

19. The apparatus of claim 16, wherein the seat is rotatably coupled to the upper platform support bars.

20. The apparatus of claim 16, wherein the stand member further comprises tree spikes.
